(19) United States
(12) Patent Application Publication
(10) Pub. No.: US 2022/0110139 A1
(43) Pub. Date: Apr. 7, 2022

(54) Method for Reliable Transmission of Early Mobile-Terminated Data

(71) Applicant: Telefonaktiebolaget LM Ericsson (publ), Stockholm (SE)

(72) Inventors: Dung Pham Van, Upplands Väsby (SE); Andreas Höglund, Solna (SE); Magnus Stattin, Upplands Väsby (SE); Tuomas Tirronen, Helsinki (FI); Emre Yavuz, Stockholm (SE)

(21) Appl. No.: 17/426,239

(22) PCT Filed: Jan. 29, 2020
(86) PCT No.: PCT/IB2020/050708

§ 371 Date: Jul. 28, 2021

Related U.S. Application Data
(60) Provisional application No. 62/798,862, filed on Jan. 30, 2019.

(51) Int. Cl. H04W 72/12; H04W 74/04; H04W 72/14

(52) U.S. Cl. CPC H04W 72/1273; H04W 74/04; H04W 68/00; H04W 72/1289; H04W 72/14

(57) ABSTRACT

Embodiments include methods for a user equipment (UE) to receive downlink user data from a wireless network. Such methods include receiving, from a network node in the wireless network, a paging message indicating that downlink user data is available for the UE, and transmitting a random-access (RA) preamble to the network node. Such methods include receiving, from the network node, a response to the RA preamble, the response including a timing advance (TA) command for timing alignment of a subsequent transmission by the UE, and either the downlink user data or scheduling information pertaining to the downlink user data. Other embodiments include complementary methods performed by a network node, as well as UEs and network nodes configured to perform such methods.

### RELATED APPLICATION(S)

The present application claims priority to U.S. Provisional Application 62/798,862 filed Jan. 30, 2019, the entirety of which is incorporated herein by reference for all purposes.

### TECHNICAL FIELD

The present invention generally relates to wireless communication networks, and particularly relates to improvements in operation of very-low-power devices in a wireless communication network.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein can be applied to any other embodiment, wherever appropriate. Likewise, any advantage of any of the embodiments can apply to any other embodiments, and vice versa. Other objectives, features and advantages of the enclosed embodiments will be apparent from the following description.

Long-Term Evolution (LTE) is an umbrella term for so-called fourth-generation (4G) radio access technologies developed within the Third-Generation Partnership Project (3GPP) and initially standardized in Releases 8 and 9, also known as Evolved UTRAN (E-UTRAN). An overall exemplary architecture of a network comprising LTE and SAE is shown in FIG. 1. E-UTRAN 100 comprises one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that is capable of communicating with 3GPP-standard-compliant network equipment, including E-UTRAN as well as UTRAN and/or GERAN, as the third-(“3G”) and second-generation (“2G”) 3GPP radio access networks are commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. The eNBs in the E-UTRAN communicate with each other via the X1 interface, as shown in FIG. 1. The eNBs also are responsible for the E-UTRAN interface to the EPC 130, specifically the S1 interface to the Mobility Management Entity (MME) and the Serving Gateway (SGW), shown collectively as MME/S-GWs 134 and 138 in FIG. 1. Generally speaking, the MME/S-GW handles both the overall control of the UE and data flow between the UE and the rest of the EPC. The S-GW handles all Internet Protocol (IP) data packets (e.g., data or user plane) between the UE and the EPC, and serves as the local mobility anchor for the data bearers when the UE moves between eNBs, such as eNBs 105, 110, and 115.

EPC 130 can also include a Home Subscriber Server (HSS) 131, which manages user- and subscriber-related information. In some embodiments, HSS 131 can communicate with a user data repository (UDR)—labelled EPC-UDR 135 in FIG. 1—via a Ud interface. The EPC-UDR 135 can store user credentials after they have been encrypted by AuC algorithms.

FIG. 2A shows a high-level block diagram of an exemplary LTE architecture in terms of its constituent entities—UE, E-UTRAN, and EPC—and high-level functional division into the Access Stratum (AS) and the Non-Access Stratum (NAS). FIG. 2A also illustrates two particular interface points, namely Uu (UE/E-UTRAN Radio Interface) and S1 (E-UTRAN/EPC interface), each using a specific set of protocols, i.e., Radio Protocols and S1 Protocols.

FIG. 2B illustrates a block diagram of an exemplary Control (C)-plane protocol stack between a UE, an eNB, and an MME. The exemplary protocol stack includes Physical (PHY), Medium Access Control (MAC), Radio Link Control (RLC), Packet Data Convergence Protocol (PDCP), and Radio Resource Control (RRC) layers between the UE and eNB. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PDCP layer provides ciphering/deciphering and integrity protection for both U-plane and C-plane, as well as other functions for the U-plane such as header compression. The exemplary protocol stack also includes non-access stratum (NAS) signaling between the UE and the MME.

The RRC layer controls communications between a UE and an eNB at the radio interface, as well as the mobility of a UE between cells in the E-UTRAN. After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “On durations”), an RRC_IDLE UE receives system information (SI) broadcast by a serving cell, performs measurements of neighbor cells to support cell reselection, and monitors a paging channel on PDCCH for pages from the EPC via eNB. A UE in RRC_IDLE state is known in the EPC and has an assigned IP address, but is not known to the serving eNB (e.g., there is no stored context).

Generally speaking, a physical channel corresponds to a set of resource elements carrying information that originates from higher layers. Downlink (i.e., eNB to UE) physical channels provided by the LTE PHY include Physical Downlink Shared Channel (PDSCH), Physical Downlink Control Channel (PDCCH), and Physical Hybrid ARQ Indicator Channel (PHICH). In addition, the LTE PHY downlink includes various reference signals, synchronization signals, and discovery signals.

PDSCH is the main physical channel used for unicast DL data transmission, but also for transmission of RAR (random access response), certain system information blocks, and paging information. PHICH carries HARQ feedback (e.g., ACK/NAK) for UL transmissions by the UEs. Similarly, PDCCH carries DL scheduling assignments (e.g., for PDSCH), UL resource grants (e.g., for PUSCH), channel quality feedback (e.g., CSI) for the UL channel, and other control information.

Uplink (i.e., UE to eNB) physical channels provided by the LTE PHY include Physical Uplink Shared Channel (PUSCH) and Physical Uplink Control Channel (PUCCH). PUSCH is the counterpart of PDSCH, used primarily for unicast UL data transmission. Similar to PDCCH, PUCCH carries uplink control information (UCI) such as scheduling requests, CSI for the DL channel, HARQ feedback for eNB DL transmissions, and other control information.

Recently, there has been a significant amount of 3GPP standardization activity toward specifying LTE enhancements to cover Machine-to-Machine (M2M) and/or Internet of Things (IoT) related use cases. 3GPP Releases 13 (Rel-13) and 14 (Rel-14) include enhancements to support Machine-Type Communications (MTC) with new UE categories (e.g., Cat-M1, Cat-M2), supporting reduced bandwidth of six physical resource blocks (PRBs) (or up to 24 PRBs for Cat-M2), and Narrowband IoT (NB-IoT) UEs having a new NB radio interface with corresponding new UE categories (e.g., Cat-NB1 and Cat-NB2). In the following discussion, the term “eMTC” is used to distinguish MTC-related LTE enhancements introduced in 3GPP Releases 13-15 from NB-IoT-specific features.

In Rel-16, there are work items (WIs) for specifying support for mobile-terminated (MT) early data transmission (EDT) in both eMTC and NB-IoT. However, detailed solutions for these objectives have not been specified. Accordingly, there remains a need for a solution to facilitate secure and reliable transmission of MT EDT (e.g., downlink) data with reduced and/or minimal signaling required between the UE and a serving network node.

### SUMMARY

Embodiments of the present disclosure provide specific improvements to communication between user equipment (UE) and network nodes in a wireless communication network, such as by facilitating solutions to overcome the exemplary problems described above.

Some exemplary embodiments of the present disclosure include methods (e.g., procedures) for receiving downlink user data from a wireless communication network. These exemplary methods can be performed by a user equipment (e.g., UE, wireless device, MTC device, NB-IoT device, modem, etc. or component thereof) in communication with a network node (e.g., base station, eNB, gNB, etc., or component thereof) serving a cell in the network.

These exemplary methods can include receiving, from the network node, a paging message indicating that downlink user data is available for the UE, and transmitting a random-access (RA) preamble to the network node. These exemplary methods can also include receiving a response to the RA preamble from the network node. The response can include a timing advance (TA) command for timing alignment of a subsequent transmission by the UE, and the downlink user data or scheduling information pertaining to the downlink user data.

Other exemplary embodiments of the present disclosure include methods (e.g., procedures) for transmitting downlink user data to a user equipment (UE). These exemplary methods can be performed by a network node (e.g., base station, eNB, gNB, etc., or component thereof) serving one or more user equipment (e.g., UE, wireless device, MTC device, NB-IoT device, modem, etc.) in a cell of a wireless network.

These exemplary methods can include transmitting, to the UE, a paging message indicating that downlink user data is available for the UE, and receiving a random-access (RA) preamble from the UE. These exemplary methods can also include transmitting a response to the RA preamble to the UE. The response can include a TA command for timing alignment of a subsequent transmission by the UE, and the downlink user data or scheduling information pertaining to the downlink user data.

Other exemplary embodiments include user equipment or network nodes configured to perform operations corresponding to any of the exemplary methods described herein. Other exemplary embodiments include non-transitory, computer-readable media storing program instructions that, when executed by processing circuitry, configure such network nodes or UEs to perform operations corresponding to any of the exemplary methods described herein.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an exemplary architecture of the Long-Term Evolution (LTE) Evolved UTRAN (E-UTRAN) and Evolved Packet Core (EPC) network, as standardized by 3GPP.

FIG. 2A is a high-level block diagram of an exemplary E-UTRAN architecture in terms of its constituent components, protocols, and interfaces.

FIG. 2B is a block diagram of exemplary protocol layers of the control-plane portion of the radio (Uu) interface between a user equipment (UE) and the E-UTRAN.

FIG. 3, which includes FIGS. 3A-3B, shows two exemplary Random Access (RA) procedures for an LTE UE.

FIG. 4 shows an exemplary MAC protocol data unit (PDU) containing one or more RA Response (RAR) messages.

FIG. 5 shows an exemplary signaling flow diagram for mobile-terminated (MT) early data transmission (EDT) in an LTE network, according to various exemplary embodiments of the present disclosure.

FIG. 6 shows an exemplary MAC PDU containing one or more RAR messages and additional information (e.g., DL user data for MT-EDT) in a padding section, according to various exemplary embodiments of the present disclosure.

FIG. 7 shows an exemplary MAC PDU containing one or more MAC control elements (CEs) and a MAC service data unit (SDU) containing user data for MT-EDT, according to various exemplary embodiments of the present disclosure FIG. 8 shows a flow diagram of an exemplary method performed by a user equipment according to various exemplary embodiments of the present disclosure.

FIG. 9 shows a flow diagram of an exemplary method performed by a network node in a wireless network, according to various exemplary embodiments of the present disclosure.

FIG. 10 shows a block diagram of an exemplary wireless device or UE according to various exemplary embodiments of the present disclosure.

FIG. 11 shows a block diagram of an exemplary network node according to various exemplary embodiments of the present disclosure.

FIG. 12 shows a block diagram of an exemplary network configured to provide over-the-top (OTT) data services between a host computer and a UE, according to various exemplary embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Furthermore, various terms discussed below will be used throughout the application.

As used herein, a “radio access node” (or equivalently “radio network node” or “radio access network node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (network node) in a 3GPP LTE network), a high-power or macro base station, a low-power base station (e.g., a micro base station, a pico base station, a home eNB, or the like), an integrated access backhaul (IAB) node, and a relay node.

As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some exemplary WDs or UEs include, but are not limited to, device-to-device (D2D) WDs, low-cost and/or low-complexity WDs, sensors equipped with WD, tablets, mobile terminals, smart phones, laptop embedded equipment (LEE), laptop mounted equipment (LME), USB dongles, customer premises equipment (CPE), Internet of Things (IoT) devices, Narrowband IoT (NB-IOT) devices, machine-type communication (MTC or M2M) devices, aerial devices (e.g., drones), ProSe UE, V2V UE, V2X UE, etc.

As used herein, a “network node” is any node that is either part of the radio access network or the core network of a cellular communications network. For example, a network node can be a radio access node, as defined above. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Although terminology from one or more specific wireless systems (e.g., LTE) may be used herein, this should not be seen as limiting the scope of the disclosure to only those specific wireless system(s). Other wireless systems, including Wide Band Code Division Multiple Access (WCDMA), Worldwide Interoperability for Microwave Access (WiMax), Ultra Mobile Broadband (UMB), and Global System for Mobile Communications (GSM), 5G/NR (or “New Radio”) may also benefit from principles and/or embodiments of the present disclosure. For example, although the term “cell” is used herein, it should be understood that 5G/NR beams may be used instead of cells and, as such, concepts described herein apply equally to cells and beams.

As briefly mentioned above, although objectives have been set in 3GPP, there is a need for a detailed solution to facilitate secure and reliable mobile-terminated early data transmission (MT EDT) with reduced and/or minimal signaling required between the UE and a serving network node. This is discussed in more detail below.

Several enhancements to support M2M- and/or IoT-related use cases were specified in 3GPP Rel-13 and Rel-14. These enhancements include newly defined physical channels, (e.g., MPDCCH in eMTC and NPDCCH in NB-IoT), a new physical random-access channel for NB-IoT (e.g., NPRACH), and coverage level enhancements. For example, by applying repetitions to the transmitted signals and channels, both eMTC and NB-IoT facilitate UE operation at a much lower signal-to-noise-ratio (SNR, also referred to as Es/IoT) compared to LTE. For example, eMTC and NB-IoT have an operating point of Es/IoT≥−15 dB, while “legacy” LTE UEs can only operate down to −6 dB Es/IoT—a significant, 9-dB enhancement.

3GPP Rel-13 also included signaling reductions and/or improvements for both eMTC and NB-IoT. One improvement, known as “CIoT EPS UP optimization,” allows the UE to resume a previously stored RRC connection (thus is also referred to as “RRC Suspend/Resume”). In addition, “CIoT EPS CP optimization” (also referred to as “DoNAS”) allows transmission of user-plane data over Non-Access Stratum (NAS) signaling.

Additional work items (WIs) called “Even further enhanced MTC for LTE (LTE_eMTC4)” [WI_eMTC] and “Further NB-IoT enhancements (NB_IOTenh2)” [WI_NBIOT] were introduced in Rel-15, targeting eMTC and NB-IoT, respectively. The objective of these WIs was to reduce UE power consumption and latency through introducing possibilities to send data as early as possible during the Random Access (RA) procedure. This feature is commonly referred to as “early data transmission” (or “EDT” for short).

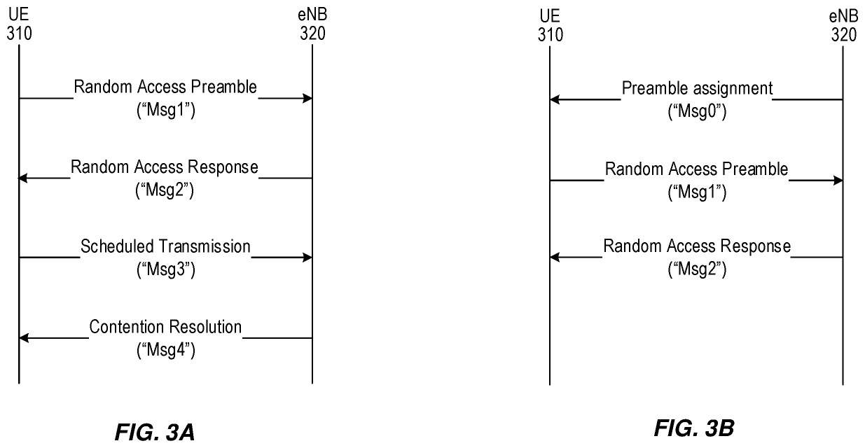

FIG. 3, which includes FIGS. 3A-3B, shows two exemplary Random Access (RA) procedures for an LTE UE 310, such as an eMTC or NB-IoT UE. In general, the UE can perform a RA procedure during various situations including: initial access from RRC_IDLE state; RRC connection re-establishment; handover; and UL or DL data arrival in RRC_CONNECTED state when the UE is unsynchronized with serving eNB 320. In the following description of FIGS. 3A-3B, UE 310 and eNB 320 will be referred to without their reference numbers.

FIG. 3A shows an exemplary contention-based RA (CBRA) procedure. In the CBRA procedure shown in FIG. 3A, the UE initially selects one of the RA preambles available in the serving cell and transmits it to the eNB. This transmission is referred to as “Msg1.” If the eNB receives the preamble correctly (due to, e.g., no collisions with other UEs transmitting the same preamble), it sends a random-access response (RAR, also referred to as “Msg2”) to the UE. Typically, the RAR includes a timing advance (TA) command for alignment of subsequent UE transmissions, a grant of UL resources for subsequent UE transmission (“UL grant”), and a temporary identifier assigned to the UE in the cell (“C-RNTI”).

As shown in FIG. 3A, if the UE correctly receives the RAR, it responds with the transmission scheduled by the UL grant in the RAR and includes the C-RNTI assigned by the RAR. This transmission is also referred to as “Msg3.” If the eNB correctly receives Msg3, it responds with a contention resolution message (“Msg4”).

FIG. 3B shows a contention-free RA (CFRA) procedure. In this procedure, the eNB initially transmits (in “Msg0”) an assignment of a specific RA preamble for the UE to use when accessing a cell. This can occur, e.g., during preparation of UE handover to a target cell where it must perform a RA procedure. Subsequently, the UE transmits the assigned RA preamble (“Msg1”) and, if received correctly, the eNB responds with a RAR (“Msg2”). Since there is no contention due to the assigned preamble, the CBRA procedure does not include exchange of Msg3 and Msg4.

Conventionally, the UE and eNB can communicate user data after the RA procedure is completed. As mentioned above, however, a goal of EDT is to facilitate sending data as early as possible during the RA procedure. Since RAN2 WG meeting #99, it has been agreed within 3GPP to support transmission of data in Msg3 and/or Msg4 of CBRA, depending on actual use cases for both Rel-13 UP and CP solutions. However, only EDT solutions for mobile-originated (MO) user data are specified in Rel-15. In MO EDT, the UE with small UL user data can indicate its intention of sending UL user data in Msg3 by selecting an EDT preamble to transmit in Msg1. The eNB provides the UE with an EDT UL grant in Msg2 that allows the UE to transmit UL data together with signaling in Msg3.

Depending on UL data conditions, the UE can select a suitable (e.g., smallest) value of transport block size (TBS) among the possible values specified based on the maximum TBS value and the permitted number of blind decodes (i.e., number of TBS values smaller than the maximum value) informed by the eNB via system information. If needed, the eNB can include DL data to the UE in Msg4, together with signaling indicating that the UE should return to RRC_IDLE state (e.g., to reduce energy consumption) if no more data transmission is expected. On the other hand, if there are more user data to be transmitted to the UE, the network can indicate the UE (e.g., in Msg4) to move to RRC_CONNECTED state, thereby establishing or resuming the RRC connection for operation according to conventional techniques.

In Rel-16, WIs exist for specifying support for mobile-terminated (MT) EDT in both eMTC and NB-IoT. More specifically, an objective is to specify EDT techniques to improve DL transmission efficiency and/or UE power consumption for machine-type communications (MTC) for BL/CE UEs and NB-IoT FDD UEs. MT EDT was discussed in RAN2 #103bis and RAN2 #104 WG meetings, with following agreements being reached:
RAN2 intends to support MT-initiated EDT for both CP and UP solutions.
The intention to use MT-EDT is for user data, i.e. not for NAS signaling.
MT EDT are evaluated at least based on battery life, network resource efficiency, security, reliability and potential impact on core network.
MT-EDT is intended for DL data which can be transmitted in one transport block.
Use cases that require DL data transmission with or without UL data transmission as a response should be supported for MT-EDT.

Furthermore, in the RAN2 #104 meeting, several MT-EDT options were proposed and the following use cases and/or criteria to choose MT-EDT options were agreed:
MT EDT are evaluated at least based on battery life, network resource efficiency, security, reliability and potential impact on core network.
MT-EDT is intended for DL data which can be transmitted in one transport block.
Use cases that require DL data transmission with or without UL data transmission as a response should be supported for MT-EDT.

One alternative is to use existing MT call procedures, but these do not meet the requirements for reducing UE energy consumption and network signaling. To this extent, different alternatives have been discussed in 3GPP, e.g., sending MT EDT (or a schedule for EDT) within the paging message to the UE, sending MT data after Msg1 transmission, or sending data in Msg4 by re-using the MO EDT solution. In particular, the following seven (7) solution options are under consideration:

1. Paging based option A: DL data transmitted in paging message

2. Paging based option B: RNTI transmitted in paging message

3. Paging based option C: DL grant scheduled in paging message

4. Paging based option D: DL data scheduled in paging occasion

5. DL data after preamble

6. DL data in Msg4-A

7. DL data in Msg4-B

The first opportunity for transmission of MT DL data to the UE is in the paging message sent by the network to the UE (option 1 above). However, putting UE-specific data in a paging message has several disadvantages. First, other UEs that share the paging occasion with the intended UE may need to decode the larger paging message, which unnecessarily consumes energy in those other UEs. Second, this approach can waste a large amount of RAN and CN resources, since it can significantly increase paging load in a cell and possibly require transmission of the DL data and signaling by multiple eNBs serving all cells within the tracking area of the intended UE.

A variation of the mechanism described above is to schedule the MT DL data in the paging message rather than providing the MT DL data in the paging message (option 3 above). Another variation of the paging-based MT-EDT option is to schedule DL data in a paging occasion rather than in the paging message itself (option 4 above). Although more radio resources would still be needed, the impact on other UEs power consumption from message decoding would be reduced for both of these options.

The next opportunity for transmission of MT DL data to the UE is immediately after the preamble transmission (Msg1) in the RA procedure. One possibility is to use a CFRA-like approach where the UE transmits “Msg1” using an assigned preamble, and the eNB transmits a “Msg2” including the DL user data in response to Msg1. The assigned CFRA preamble can be indicated, e.g., in the paging message sent to the UE from the eNB. The UE may need to send an UL ACK for the DL data and/or an UL data transmission in response to DL data transmission. However, it is problematic since the UE may not have valid TA, such that there is no time alignment for UL transmissions (e.g., PUCCH/PUSCH). Consequently, the DL transmission cannot be acknowledged which renders this approach unusable.

Accordingly, exemplary embodiments of the present disclosure provide novel, flexible, and efficient techniques for timing adjustment at UE after MT-EDT DL data transmission based on reduced signaling. For example, a timing advance (TA) command can be included in a Msg2 during a CFRA procedure. The exemplary Msg2 can also include the DL data or a scheduling of resources for the DL data. By using a TA command received in this manner for UL timing alignment, the UE can reliably transmit UL feedback (e.g., ACK/NAK) in response to MT-EDT DL data transmission (e.g., in Msg2), as well as to transmit other responsive UL data as needed.

Embodiments of the present disclosure can have different aspects. In a first aspect, a RAR message during a CFRA procedure can be extended and/or improved to include: 1) a TA command sufficient for the UE to adjust its timing alignment over a wide range of values; and 2) DL data or scheduling information (e.g., downlink control information (DCI)) for subsequent transmission of DL data. In a second aspect, a transmission that conveys DL user data (e.g., a in response to a CFRA Msg1 can also include: 1) a TA command sufficient for the UE to adjust its timing alignment over a wide range of values; and 2) possibly other information conventionally conveyed in a RAR message, such as an UL grant for subsequent UE transmissions.

One exemplary advantage of such novel techniques is reduction and/or minimization of the signaling required between UE and network in relation to the MT-EDT procedure. Another exemplary advantage is that such techniques are applicable to both CP and UP CIoT EPS optimization solutions. Another exemplary advantage is that such techniques reduce UE energy consumption and improve latency for small-data transmissions compared to conventional MT data transmission procedures.

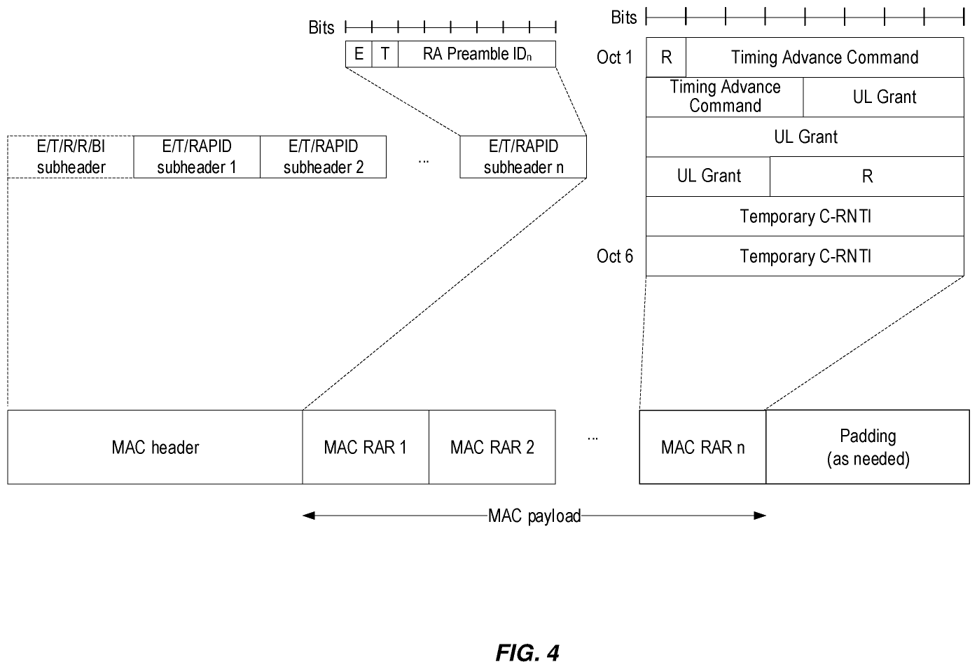

FIG. 4 shows an exemplary MAC protocol data unit (PDU) containing one or more RA Response (RAR) messages. The exemplary MAC PDU shown in FIG. 4 is used to illustrate conventional RAR operation in LTE networks. As shown in FIG. 4, the MAC PDU consists of MAC header and MAC payload sections, together with an optional padding following the payload as needed. The MAC header shown consists of n MAC PDU subheaders, each corresponding to one of n MAC RARs in the payload section. Each of the n MAC subheaders includes E, T, and RAPID fields. As shown in FIG. 4, the RAPID field in the nth subheader includes an identifier of a particular RA preamble associated with the nth RAR message. In this manner, a UE receiving the MAC PDU shown in FIG. 4 can determine if it includes a RAR corresponding to a RA preamble transmitted by the UE in Msg1. As shown in FIG. 4, RAPID is six bits long, allowing the network to identify 64 different RA preambles.

FIG. 4 also shows exemplary contents of the nth MAC RAR. The exemplary RAR is six (6) octets long and includes a 11-bit TA command, a 15-bit UL grant identifying resources for the UE to use to subsequently transmit a responsive message (e.g., Msg3), and a 16-bit temporary identifier (C-RNTI) for the UE to use to identify itself in subsequent transmissions. Two fields of reserved (R) bits are also included in the exemplary MAC RAR shown in FIG. 4.

In the first aspect, after the UE has transmitted a RA preamble successfully received by the eNB, the eNB can include the DL data in a responsive Msg2 together with the RAR, scheduled via PDCCH using a legacy RNTI (e.g., RA-RNTI) or a newly introduced RNTI for such purpose. In one example, rather than the DL data itself, scheduling for DL data transmission can be provided in Msg2 (e.g., in a MAC RAR or an extension thereof) transmitted prior to the actual DL data transmission. In this manner, the scheduling and DL data transmission are separated, thereby facilitating possible retransmissions of the DL data as needed. In other embodiments, scheduling for DL data transmission can be provided via PDCCH scrambled with an ID (e.g., RNTI) provided to the UE in a paging message.

In general, a MAC RAR may need to be sent together with the DL data transmission in response to CFRA PRACH transmission for various reasons. For example, temporary C-RNTI in a RAR may be needed to enable retransmissions in case no identifier is provided in the paging message to the UE. As another example, the UE may need the random access preamble ID (RAPID) to identify and match with its previously transmitted CFRA preamble. As yet another example, TA may be needed for UE timing adjustment. According to the first aspect, some or all of the above information can be sent to the UE in the form of MAC RAR accompanying the DL data (or scheduling DCI for the DL data).

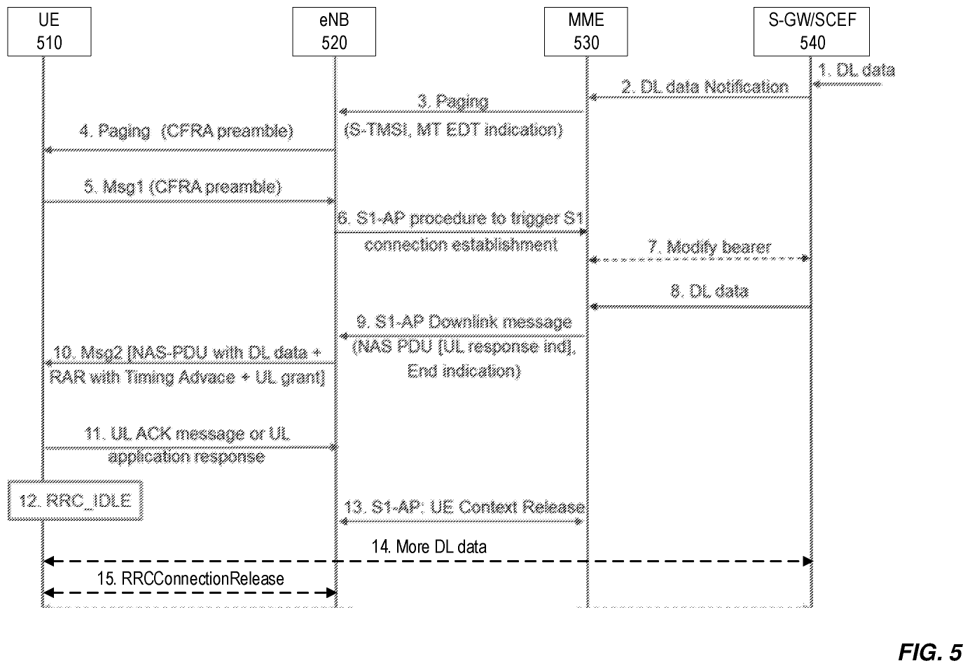

FIG. 5 shows an exemplary signaling flow diagram for mobile-terminated (MT) early data transmission (EDT) in an LTE network, according to various exemplary embodiments of the present disclosure. FIG. 5 shows operations labelled in numerical order. Unless specifically noted, however, this numerical order does not correspond to a required sequential or logical ordering of the depicted operations. Rather, unless otherwise specifically noted, the numbers are used only to facilitate explanation and understanding.

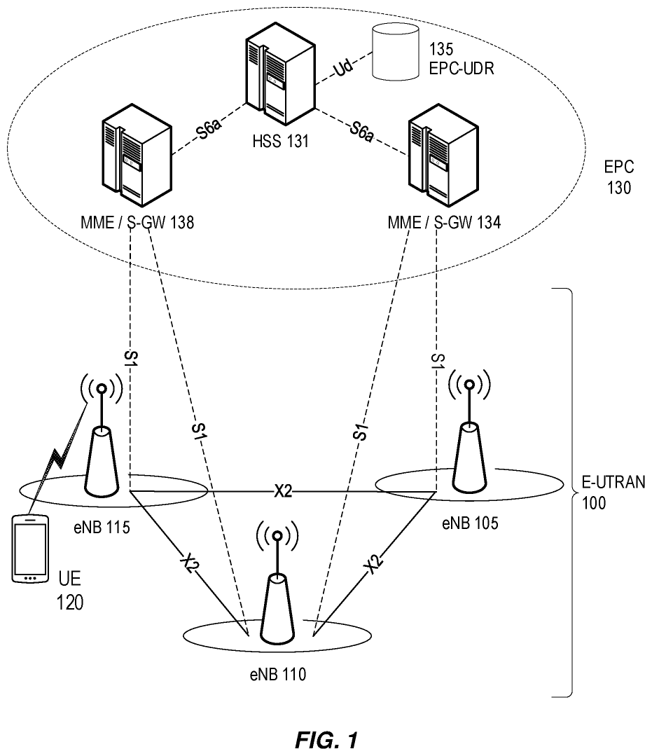

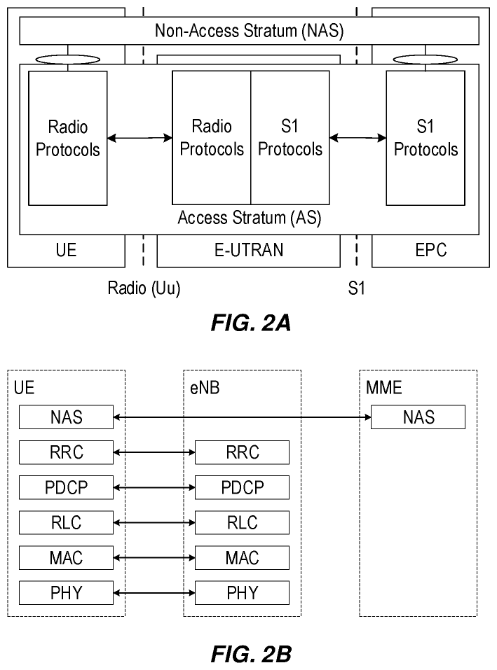

The operations shown in FIG. 5 are performed by, or among, a UE 510, an eNB 520, an MME 530, and a Serving Gateway (S-GW) or Service Capability Exposure Function (S-GW/SCEF) 540. In the following description, these entities are referred to without their reference numbers. Initially, in operation 1, DL data intended for the UE arrive at the S-GW for the UE in the LTE network (e.g., as illustrated in the exemplary network shown in FIG. 1). In operation 2, the S-GW sends a notification to the MME serving the network (or portion thereof) where the UE is located. Subsequently, in operation 3, the MME sends a paging request to one or more eNBs in a tracking area where the UE is located, including the serving eNB for the UE (shown in FIG. 5). The MME can include in the paging request a UE identifier (S-TMSI) and an indication that user data is available for EDT to the UE.

After receiving the paging request, in operation 4, the eNB sends a paging message to (or “pages”) the UE. The UE can include in the paging message an identity of a CFRA preamble for the UE to use when accessing the cell served by the eNB. In operation 5, after receiving the page, the UE transmits Msg1 using the assigned CFRA preamble. After receiving the CFRA preamble previously assigned, the eNB can determine an appropriate timing advance (TA) for the UE. In addition, operation 6, the eNB initiates an S1-AP procedure to trigger an S1 connection establishment with the MME. In operation 8, the MME receives the DL data from the S-GW, after modifying a DL bearer as necessary in operation 7.

In operation 9, the MME sends the eNB a downlink message over the S1-AP connection, with the message including a NAS PDU carrying the DL data intended for the UE. The downlink message can also include an indication that a UE UL response is requested. In some embodiments, the downlink message can also include an “end indication,” which signals that there is no more pending DL data available for the UE. In operation 10, the eNB can send the UE a Msg2 (in response to the earlier Msg1) that includes a RAR with a TA command (with a value determined as discussed above), an UL grant for transmission of the UE response, and the DL user data.

In some embodiments, the eNB can include the “end indication”, received from the MME in operation 9, in the Msg2 sent to the UE in operation 10. In other embodiments, rather than including the “end indication” in Msg2, the eNB can send an appropriate RRC message (not shown in FIG. 5) indicating that the UE should return to RRC_IDLE state. This RRC message can be in response to, or based on, the “end indication” received in operation 9. In some embodiments, this RRC message can include the “end indication” or a representation thereof.

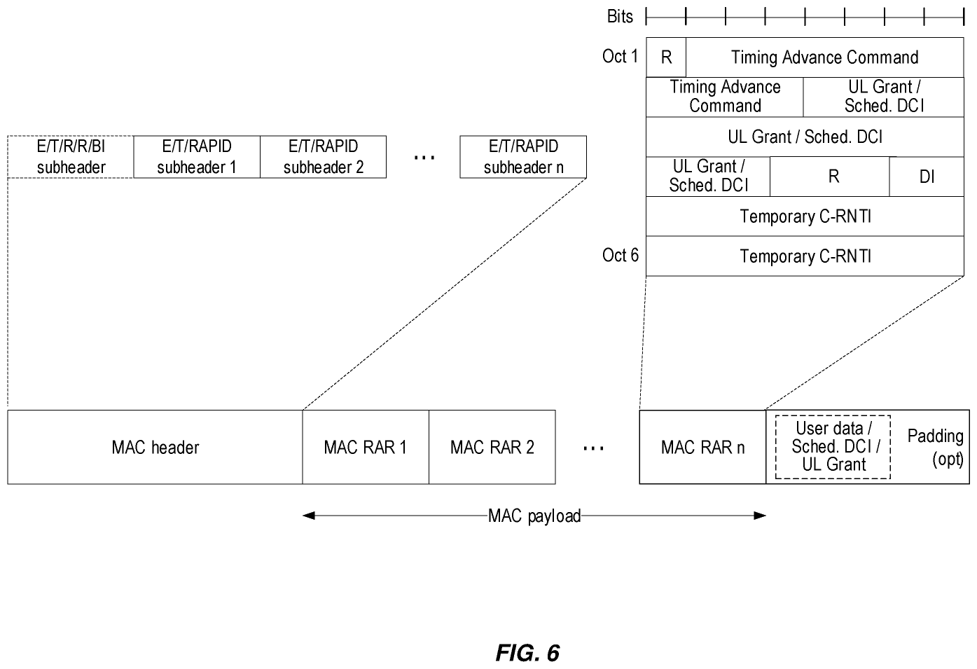

In some alternate embodiments, the Msg2 can include scheduling information (e.g., DCI) for subsequent transmission of the DL user data, rather than the user data itself. These are discussed in more detail below with reference to FIG. 6.

In operation 11, after receiving the Msg2 from the eNB, the UE responds as requested using the granted UL resources. For example, the response can be an ACK/NAK with respect to the reception of the DL data, either from the MAC layer or from a higher (e.g., application) layer. In operation 12, the UE can determine whether to return to RRC_IDLE state. This can be based on, e.g., the presence of the “end indication” in the Msg2 received in operation 10. This determination can also be based on expiration of a timer that is initiated by the UE after receiving the DL data (operation 10) or transmitting the response (operation 11). For example, to trigger an immediate return to RRC_IDLE state, the UE can initiate the timer with a value of zero. As another example, the UE can determine whether to return to RRC_IDLE state based on an appropriate RRC message received from the eNB (not shown in FIG. 5), which was discussed above in relation to operations 9-10.

In operation 13, since there is no more DL data for the UE, the eNB and MME perform a UE context release procedure. Optionally, the UE and S-GW can exchange more DL data before the UE performs an RRC Connection Release with the eNB (operations 14-15).

FIG. 6 shows an exemplary MAC PDU containing one or more RAR messages and additional information (e.g., DL user data for MT-EDT) in a padding section, according to various exemplary embodiments of the present disclosure. The exemplary MAC PDU is similar in many ways to the MAC PDU shown in FIG. 4, with the primary differences being in the MAC RAR itself and in the padding region following the MAC payload.

As shown in FIG. 6, the nth RAR can include an 11-bit TA command, which is sufficient for the UE to adjust its timing alignment over a wide range of values. In some embodiments, the nth RAR can also include a 16-bit UL grant for subsequent UE transmissions, similar to the nth RAR shown in FIG. 4. In such embodiments, the DL user data can be included in a portion of the padding region following the payload, as shown by dashed lines in the figure. In addition, the nth MAC RAR can include a “data indication” associated with the padding region, the value of which indicates whether or not the padding region contains DL data associated with the nth MAC RAR. This is shown as two-bit “DI” in FIG. 6.

Note, however, that if the message shown in FIG. 6 is not received successfully by the UE, there is no way for the UE to inform the network that it has not received the DL data because it is also missing the TA and RNTI included in the Msg2. As such, retransmission of the Msg2 shown in FIG. 6 is not possible.

To address these issues, rather than including the DL user data in the padding region, a scheduling DCI for the DL data can be included in the padding region. In this manner, the RAR and DL data transmissions are separated and thus retransmission can be performed for the DL data. Even so, if the initial RAR DL transmission fails, there is still no possibility of retransmission since the UE does not have a valid TA. For the second DL data transmission, which is typically larger and less-robustly coded on PHY-layer (making retransmissions are more likely), retransmission will now be possible since the UE has already received a valid TA and RNTI.

To address this problem with the initial RAR (with or without DL data appended), the eNB can transmit multiple RAR messages to the UE. For example, if the eNB has not received any acknowledgement of the RAR at the end of a RA-window plus a certain time offset to account for the UL transmission delay, the eNB could retransmit the RAR message within a second RA-window. The procedure could be repeated for a pre-configured number of RAR transmissions. Alternatively, the RA-window length can be configured differently (longer) for MT EDT to allow for eNB to transmit many RA response messages.

In other embodiments, the 16-bit field in the nth RAR can include the scheduling DCI for the DL data rather than the UL grant. In such embodiments, the DL data is not included in the padding region, so the UL grant can be included in the padding region instead.

In other embodiments, a ciphering algorithm can be used to scramble the UL ACK transmissions and retransmissions can be provided in the RAR message itself. In this manner, retransmission is only performed for the data part, not the RAR part of the DL message.

In the second aspect, a transmission that conveys DL user data (e.g., in response to a CFRA Msg1) can also include the RAR or selected content of it, appended to the MT DL user data. For example, in the user-plane (UP) MT-EDT solution, the MT DL data on DTCH can be multiplexed with the RAR on CCCH/DTCH. In this case, a new RAR format can be defined with only information necessary for MT-EDT use, i.e., with minimal size.

In one embodiment, the DL transmission in response to CFRA Msg1 can include only information about TA. This can be beneficial in situations where there is no need for the RAPID and/or temporary C-RNTI (e.g., an RNTI was already provided in paging). In such case, the TA command can be provided as a MAC CE.

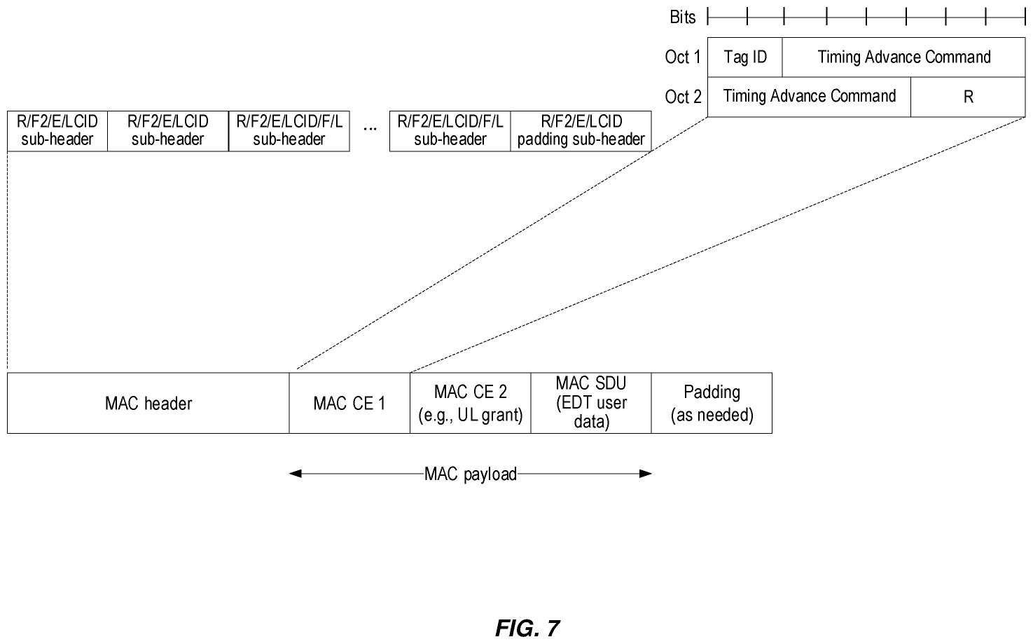

The above alternatives for retransmission of Msg2 also applies to this case. FIG. 7 shows an exemplary MAC PDU containing one or more MAC control elements (CEs) and a MAC service data unit (SDU) containing user data for MT-EDT, according to various embodiments of the present disclosure. As shown in FIG. 7, the MAC PDU consists of MAC header and MAC payload sections, together with an optional padding following the payload as needed. The MAC header shown consists of various MAC PDU subheaders, including two R/F2/E/LCID subheaders and two or more R/F2/E/LCID/L subheaders.

The exemplary MAC payload portion contains two MAC CEs and a MAC SDU, e.g., for user data. One of the MAC CEs is a Timing Advance CE, such as discussed above. In contrast to existing Timing Advance CEs defined in 3GPP TS 36.321, the exemplary MAC CE 1 shown in FIG. 7 includes an 11-bit TA command field, similar to the TA command field of the MAC RAR shown in FIG. 6. Unlike the 7-bit TA command field of the existing Timing Advance CE, which only allows for limited range, this 11-bit field is sufficient for the UE to adjust its timing alignment over a wide range of values.

In some embodiments, the exemplary MAC PDU shown in FIG. 7 can include a second MAC CE (labelled “MAC CE 2” in FIG. 7) with additional information that is conventionally transmitted as part of a RAR. For example, the second MAC CE can include an UL grant of resources for the UE to use for subsequent transmissions. The MAC SDU following the second MAC CE can include the user data to be sent to the UE according to the MT-EDT techniques.

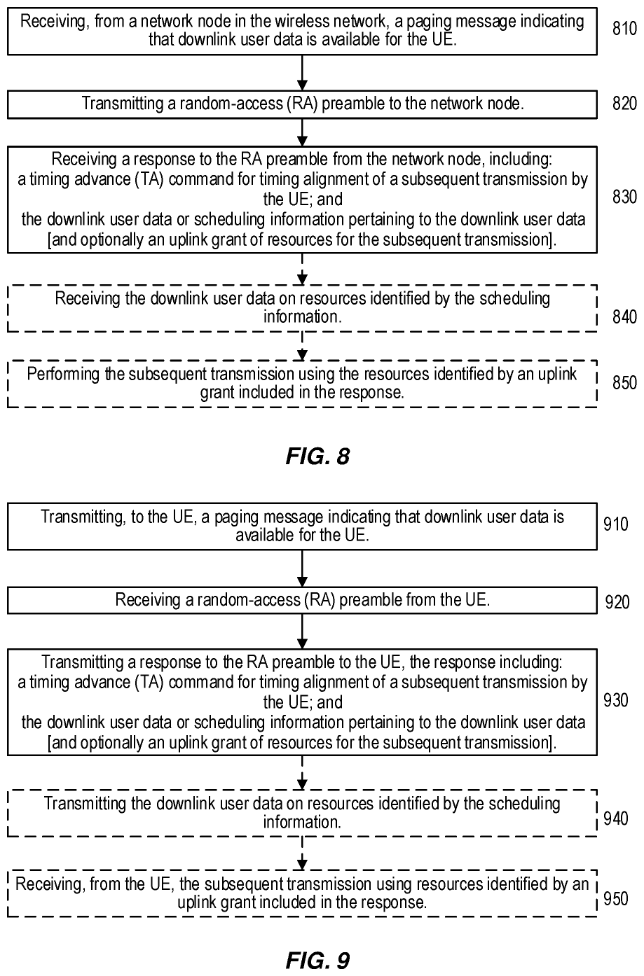

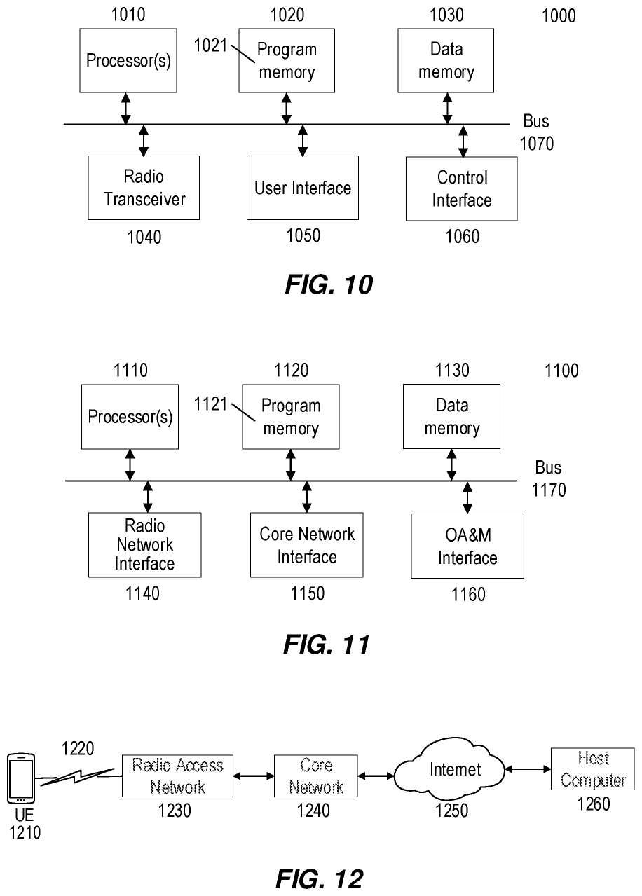

The embodiments described above can be further illustrated with reference to FIGS. 9-10, which show exemplary methods (e.g., procedures) performed by UEs and network nodes, respectively. Put differently, various features of the operations described below correspond to various embodiments described above.

In particular, FIG. 8 shows a flow diagram of an exemplary method (e.g., procedure) for receiving downlink user data from a wireless network, according to various exemplary embodiments of the present disclosure. The exemplary method can be performed by a user equipment (UE, e.g., wireless device, MTC device, NB-IoT device, modem, etc. or component thereof) in communication with a network node (e.g., base station, eNB, gNB, etc., or component(s) thereof) serving a cell in the wireless network (e.g., E-UTRAN). For example, the exemplary method shown in FIG. 8 can be implemented in a UE configured according to other figures described herein. Furthermore, the exemplary method shown in FIG. 8 can be used cooperatively with other exemplary methods described herein (e.g., FIG. 9) to provide various exemplary benefits described herein. Although FIG. 8 shows specific blocks in a particular order, the operations of the exemplary method can be performed in a different order than shown and can be combined and/or divided into blocks with different functionality than shown. Optional blocks or operations are indicated by dashed lines.

The exemplary method can include the operations of block 810, where the UE can receive, from the network node, a paging message indicating that downlink user data is available for the UE. The exemplary method can also include the operations of block 820, where the UE can transmit a random-access (RA) preamble to the network node. In some embodiments, the RA preamble can be a contention-free random-access (CFRA) preamble. In some embodiments, the paging message received in block 810 can identify the RA preamble to be transmitted in block 820.

The exemplary method can also include the operations of block 830, where the UE can receive, from the network node, a response to the RA preamble. The response can include a timing advance (TA) command for timing alignment of a subsequent transmission by the UE. The response can also include the downlink user data or scheduling information pertaining to the downlink user data.

In some embodiments, when the response includes the scheduling information, the exemplary method can also include the operations of block 840, where the UE can receive the downlink user data on resources identified by the scheduling information.

In other embodiments, when the response includes the uplink grant of resources for the subsequent transmission by the UE, the response can also include an uplink grant of resources for the subsequent transmission. In such embodiments, the exemplary method can also include the operations of block 850, where the UE can perform the subsequent transmission using the resources identified by the uplink grant, wherein the subsequent transmission is a positive or negative acknowledgement (ACK or NAK) of the downlink user data (i.e., included in the response). In some of these embodiments, the paging message (e.g., received in block 810) can include a temporary identifier associated with the UE. In such embodiments, the ACK or NAK can be transmitted together with the temporary identifier.

In some embodiments, the response can be a MAC random access response (RAR) protocol data unit (PDU) including: a MAC header; one or more RAR fields, one of which includes the TA command; and a padding field including the downlink user data or the scheduling information. In some of these embodiments, the RAR field that includes the TA command can also include a data indicator field having a value that indicates the presence of the downlink data or the scheduling information in the padding field. In other of these embodiments, the RAR field that includes the TA command can also include the scheduling information or an uplink grant of resources for the subsequent transmission by the UE. In such embodiments, the padding field can include the other of the uplink grant or the scheduling information.

In other embodiments, the response can be a MAC PDU including: a MAC header; a first MAC control element (CE) that includes the TA command; and a MAC service data unit (SDU) including the downlink user data. In some of these embodiments, the MAC PDU can also include a second MAC CE that includes an uplink grant of resources for the subsequent transmission by the UE.

In addition, FIG. 9 shows a flow diagram of an exemplary method (e.g., procedure) for transmitting downlink user data to a user equipment (UE), according to various exemplary embodiments of the present disclosure. The exemplary method can be performed by a network node (e.g., base station, eNB, gNB, etc., or component thereof) serving one or more user equipment. For example, the exemplary method shown in FIG. 9 can be implemented in a network node configured according to other figures described herein. Furthermore, the exemplary method shown in FIG. 9 can be used cooperatively with other exemplary methods described herein (e.g., FIG. 8) to provide various exemplary benefits described herein. Although FIG. 9 shows specific blocks in a particular order, the operations of the exemplary method can be performed in a different order than shown and can be combined and/or divided into blocks with different functionality than shown. Optional blocks or operations are indicated by dashed lines.

The exemplary method can include the operations of block 910, where the network node can transmit, to the UE, a paging message indicating that downlink user data is available for the UE. The exemplary method can also include the operations of block 920, where the network node can receive a random-access (RA) preamble from the UE. In some embodiments, the RA preamble can be a contention-free random-access (CFRA) preamble. In some embodiments, the paging message transmitted in block 99 can identify the RA preamble expected to be received in block 920.

The exemplary method can also include the operations of block 930, where the network node can transmit, to the UE, a response to the RA preamble. The response can include a timing advance (TA) command for timing alignment of a subsequent transmission by the UE. The response can also include the downlink user data or scheduling information pertaining to the downlink user data.

In some embodiments, when the response includes the scheduling information, the exemplary method can also include the operations of block 940, where the network node can transmit the downlink user data on resources identified by the scheduling information.

In other embodiments, when the response includes the uplink grant of resources for the subsequent transmission by the UE, the response can also include an uplink grant of resources for the subsequent transmission. In such embodiments, the exemplary method can also include the operations of block 950, where the network node can receive, from the UE, the subsequent transmission using the resources identified by the uplink grant, wherein the subsequent transmission is a positive or negative acknowledgement (ACK or NAK) of the downlink user data (i.e., included in the response). In some of these embodiments, the paging message (e.g., transmitted in block 99) can include a temporary identifier associated with the UE. In such embodiments, the ACK or NAK can be received together with the temporary identifier.

In some embodiments, the response can be a MAC random access response (RAR) protocol data unit (PDU) including: a MAC header; one or more RAR fields, one of which includes the TA command; and a padding field including the downlink user data or the scheduling information. In some of these embodiments, the RAR field that includes the TA command can also include a data indicator field having a value that indicates the presence of the downlink data or the scheduling information in the padding field. In other of these embodiments, the RAR field that includes the TA command can also include the scheduling information or an uplink grant of resources for the subsequent transmission by the UE. In such embodiments, the padding field can include the other of the uplink grant or the scheduling information.

In other embodiments, the response can be a MAC PDU including: a MAC header; a first MAC control element (CE) that includes the TA command; and a MAC service data unit (SDU) including the downlink user data. In some of these embodiments, the MAC PDU can also include a second MAC CE that includes an uplink grant of resources for the subsequent transmission.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

FIG. 10 shows a block diagram of an exemplary wireless device or user equipment (UE) 1000 (hereinafter referred to as “UE 1000”) according to various embodiments of the present disclosure, including those described above with reference to other figures. For example, UE 1000 can be configured by execution of instructions, stored on a computer-readable medium, to perform operations corresponding to one or more of the exemplary methods described herein.

UE 1000 can include a processor 1010 (also referred to as “processing circuitry”) that can be operably connected to a program memory 1020 and/or a data memory 1030 via a bus 1070 that can comprise parallel address and data buses, serial ports, or other methods and/or structures known to those of ordinary skill in the art. Program memory 1020 can store software code, programs, and/or instructions (collectively shown as computer program product 1021 in FIG. 10) that, when executed by processor 1010, can configure and/or facilitate UE 1000 to perform various operations, including operations corresponding to various exemplary methods described herein. As part of or in addition to such operations, execution of such instructions can configure and/or facilitate UE 1000 to communicate using one or more wired or wireless communication protocols, including one or more wireless communication protocols standardized by 3GPP, 3GPP2, or IEEE, such as those commonly known as 5G/NR, LTE, LTE-A, UMTS, HSPA, GSM, GPRS, EDGE, 1×RTT, CDMA2000, 802.11 WiFi, HDMI, USB, Firewire, etc., or any other current or future protocols that can be utilized in conjunction with radio transceiver 1040, user interface 1050, and/or control interface 1060.

As another example, processor 1010 can execute program code stored in program memory 1020 that corresponds to MAC, RLC, PDCP, and RRC layer protocols standardized by 3GPP (e.g., for NR and/or LTE). As a further example, processor 1010 can execute program code stored in program memory 1020 that, together with radio transceiver 1040, implements corresponding PHY layer protocols, such as Orthogonal Frequency Division Multiplexing (OFDM), Orthogonal Frequency Division Multiple Access (OFDMA), and Single-Carrier Frequency Division Multiple Access (SC-FDMA). As another example, processor 1010 can execute program code stored in program memory 1020 that, together with radio transceiver 1040, implements device-to-device (D2D) communications with other compatible devices and/or UEs.

Program memory 1020 can also include software code executed by processor 1010 to control the functions of UE 1000, including configuring and controlling various components such as radio transceiver 1040, user interface 1050, and/or control interface 1060. Program memory 1020 can also comprise one or more application programs and/or modules comprising computer-executable instructions embodying any of the exemplary methods described herein. Such software code can be specified or written using any known or future developed programming language, such as e.g., Java, C++, C, Objective C, HTML, XHTML, machine code, and Assembler, as long as the desired functionality, e.g., as defined by the implemented method steps, is preserved. In addition, or as an alternative, program memory 1020 can comprise an external storage arrangement (not shown) remote from UE 1000, from which the instructions can be downloaded into program memory 1020 located within or removably coupled to UE 1000, for execution of such instructions.

Data memory 1030 can include memory area for processor 1010 to store variables used in protocols, configuration, control, and other functions of UE 1000, including operations corresponding to, or comprising, any of the exemplary methods described herein. Moreover, program memory 1020 and/or data memory 1030 can include non-volatile memory (e.g., flash memory), volatile memory (e.g., static or dynamic RAM), or a combination thereof. Furthermore, data memory 1030 can comprise a memory slot by which removable memory cards in one or more formats (e.g., SD Card, Memory Stick, Compact Flash, etc.) can be inserted and removed.

Persons of ordinary skill will recognize that processor 1010 can include multiple individual processors (including, e.g., multi-core processors), each of which implements a portion of the functionality described above. In such cases, multiple individual processors can be commonly connected to program memory 1020 and data memory 1030 or individually connected to multiple individual program memories and or data memories. More generally, persons of ordinary skill in the art will recognize that various protocols and other functions of UE 1000 can be implemented in many different computer arrangements comprising different combinations of hardware and software including, but not limited to, application processors, signal processors, general-purpose processors, multi-core processors, ASICs, fixed and/or programmable digital circuitry, analog baseband circuitry, radio-frequency circuitry, software, firmware, and middleware.

Radio transceiver 1040 can include radio-frequency transmitter and/or receiver functionality that facilitates the UE 1000 to communicate with other equipment supporting like wireless communication standards and/or protocols. In some exemplary embodiments, the radio transceiver 1040 includes one or more transmitters and one or more receivers that enable UE 1000 to communicate according to various protocols and/or methods proposed for standardization by 3GPP and/or other standards bodies. For example, such functionality can operate cooperatively with processor 1010 to implement a PHY layer based on OFDM, OFDMA, and/or SC-FDMA technologies, such as described herein with respect to other figures.

In some exemplary embodiments, radio transceiver 1040 includes one or more transmitters and one or more receivers that can facilitate the UE 1000 to communicate with various LTE, LTE-Advanced (LTE-A), and/or NR networks according to standards promulgated by 3GPP. In some exemplary embodiments, the radio transceiver 1040 includes circuitry, firmware, etc. necessary for the UE 1000 to communicate with various NR, NR-U, LTE, LTE-A, LTE-LAA, UMTS, and/or GSM/EDGE networks, also according to 3GPP standards. In some embodiments, radio transceiver 1040 can include circuitry supporting D2D communications between UE 1000 and other compatible devices.

In some embodiments, radio transceiver 1040 includes circuitry, firmware, etc. necessary for the UE 1000 to communicate with various CDMA2000 networks, according to 3GPP2 standards. In some embodiments, the radio transceiver 1040 can be capable of communicating using radio technologies that operate in unlicensed frequency bands, such as IEEE 802.11 WiFi that operates using frequencies in the regions of 2.4, 5.6, and/or 60 GHz. In some embodiments, radio transceiver 1040 can include a transceiver that is capable of wired communication, such as by using IEEE 802.3 Ethernet technology. The functionality particular to each of these embodiments can be coupled with and/or controlled by other circuitry in the UE 1000, such as the processor 1010 executing program code stored in program memory 1020 in conjunction with, and/or supported by, data memory 1030.

User interface 1050 can take various forms depending on the particular embodiment of UE 1000, or can be absent from UE 1000 entirely. In various embodiments, user interface 1050 can comprise a microphone, a loudspeaker, slidable buttons, depressible buttons, a display, a touchscreen display, a mechanical or virtual keypad, a mechanical or virtual keyboard, and/or any other user-interface features commonly found on mobile phones. Certain mechanical features of the user interface 1050 can be replaced by comparable or functionally equivalent virtual user interface features (e.g., keypads, buttons, etc.) implemented via a touchscreen display. Certain embodiments of UE 1000—such as MTC/IoT/M2M devices—can have minimal or no UI 1050.

Control interface 1060 can also take various forms depending on the particular exemplary embodiment of UE 1000 and of the particular interface requirements of other devices that the UE 1000 is intended to communicate with and/or control. For example, the control interface 1060 can comprise an RS-232 interface, a USB interface, an HDMI interface, a Bluetooth interface, an IEEE (“Firewire”) interface, an I²C interface, a PCMCIA interface, or the like. In some exemplary embodiments of the present disclosure, the control interface 1060 can comprise analog interface circuitry including, for example, one or more digital-to-analog converters (DACs) and/or analog-to-digital converters (ADCs).

Persons of ordinary skill in the art can recognize the above list of features, interfaces, and radio-frequency communication standards is merely exemplary, and not limiting to the scope of the present disclosure. In other words, the UE 1000 can comprise more functionality than is shown in FIG. 10 including, for example, a video and/or still-image camera, microphone, media player and/or recorder, etc. Moreover, the processor 1010 can execute software code stored in the program memory 1020 to control such additional functionality.

FIG. 11 shows a block diagram of an exemplary network node 1100 according to various embodiments of the present disclosure, including those described above with reference to other figures. For example, exemplary network node 1100 can be configured by execution of instructions, stored on a computer-readable medium, to perform operations corresponding to one or more of the exemplary methods described herein. In some exemplary embodiments, network node 1100 can comprise a base station, eNB, gNB, or one or more components thereof. For example, network node 1100 can be configured as a central unit (CU) and one or more distributed units (DUs) according to NR gNB architectures specified by 3GPP. More generally, the functionally of network node 1100 can be distributed across various physical devices and/or functional units, modules, etc.

Network node 1100 can include processor 1110 (also referred to as “processing circuitry”) that is operably connected to program memory 1120 and data memory 1130 via bus 1170, which can include parallel address and data buses, serial ports, or other methods and/or structures known to those of ordinary skill in the art.

Program memory 1120 can store software code, programs, and/or instructions (collectively shown as computer program product 1121 in FIG. 11) that, when executed by processor 1110, can configure and/or facilitate network node 1100 to perform various operations, including operations corresponding to various exemplary methods described herein. As part of and/or in addition to such operations, program memory 1120 can also include software code executed by processor 1110 that can configure and/or facilitate network node 1100 to communicate with one or more other UEs or network nodes using other protocols or protocol layers, such as one or more of the PHY, MAC, RLC, PDCP, and RRC layer protocols standardized by 3GPP for LTE, LTE-A, and/or NR, or any other higher-layer (e.g., NAS) protocols utilized in conjunction with radio network interface 1140 and/or core network interface 1150. By way of example, core network interface 1150 can comprise the S1 or NG interface and radio network interface 1140 can comprise the Uu interface, as standardized by 3GPP. Program memory 1120 can also comprise software code executed by processor 1110 to control functions of network node 1100, including configuring and controlling radio network interface 1140, core network interface 1150, etc.

Data memory 1130 can comprise memory area for processor 1110 to store variables used in protocols, configuration, control, and other functions of network node 1100. As such, program memory 1120 and data memory 1130 can comprise non-volatile memory (e.g., flash memory, hard disk, etc.), volatile memory (e.g., static or dynamic RAM), network-based (e.g., “cloud”) storage, or a combination thereof. Persons of ordinary skill in the art will recognize that processor 1110 can include multiple individual processors (not shown), each of which implements a portion of the functionality described above. In such case, multiple individual processors may be commonly connected to program memory 1120 and data memory 1130 or individually connected to multiple individual program memories and/or data memories. More generally, persons of ordinary skill will recognize that various protocols and other functions of network node 1100 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 1140 can comprise transmitters, receivers, signal processors, ASICs, antennas, beamforming units, and other circuitry that enables network node 1100 to communicate with other equipment such as, in some embodiments, a plurality of compatible user equipment (UE). In some embodiments, interface 1140 can also enable network node 1100 to communicate with compatible satellites of a satellite communication network. In some exemplary embodiments, radio network interface 1140 can comprise various protocols or protocol layers, such as the PHY, MAC, RLC, PDCP, and/or RRC layer protocols standardized by 3GPP for LTE, LTE-A, LTE-LAA, NR, NR-U, etc.; improvements thereto such as described herein above; or any other higher-layer protocols utilized in conjunction with radio network interface 1140. According to further exemplary embodiments of the present disclosure, the radio network interface 1140 can comprise a PHY layer based on OFDM, OFDMA, and/or SC-FDMA technologies. In some embodiments, the functionality of such a PHY layer can be provided cooperatively by radio network interface 1140 and processor 1110 (including program code in memory 1120).

Core network interface 1150 can comprise transmitters, receivers, and other circuitry that enables network node 1100 to communicate with other equipment in a core network such as, in some embodiments, circuit-switched (CS) and/or packet-switched Core (PS) networks. In some embodiments, core network interface 1150 can comprise the S1 interface standardized by 3GPP. In some embodiments, core network interface 1150 can comprise the NG interface standardized by 3GPP. In some exemplary embodiments, core network interface 1150 can comprise one or more interfaces to one or more AMFs, SMFs, SGWs, MMEs, SGSNs, GGSNs, and other physical devices that comprise functionality found in GERAN, UTRAN, EPC, 5GC, and CDMA2000 core networks that are known to persons of ordinary skill in the art. In some embodiments, these one or more interfaces may be multiplexed together on a single physical interface. In some embodiments, lower layers of core network interface 1150 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

In some embodiments, network node 1100 can include hardware and/or software that configures and/or facilitates network node 1100 to communicate with other network nodes in a RAN (also referred to as a “wireless network”), such as with other eNBs, gNBs, ng-eNBs, en-gNBs, IAB nodes, etc. Such hardware and/or software can be part of radio network interface 1140 and/or core network interface 1150, or it can be a separate functional unit (not shown). For example, such hardware and/or software can configure and/or facilitate network node 1100 to communicate with other RAN nodes via the X2 or Xn interfaces, as standardized by 3GPP.

OA&M interface 1160 can comprise transmitters, receivers, and other circuitry that enables network node 1100 to communicate with external networks, computers, databases, and the like for purposes of operations, administration, and maintenance of network node 1100 or other network equipment operably connected thereto. Lower layers of OA&M interface 1160 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. In some embodiments, one or more of radio network interface 1140, core network interface 1150, and OA&M interface 1160 may be multiplexed together on a single physical interface, such as the examples listed above.

FIG. 12 is a block diagram of an exemplary communication network configured to provide over-the-top (OTT) data services between a host computer and a user equipment (UE), according to various exemplary embodiments of the present disclosure. UE 1210 can communicate with radio access network (RAN, also referred to as “wireless network”) 1230 over radio interface 1220, which can be based on protocols described above including, e.g., LTE, LTE-A, and 5G/NR. For example, UE 1210 can be configured and/or arranged as shown in other figures discussed above.

RAN 1230 can include one or more terrestrial network nodes (e.g., base stations, eNBs, gNBs, controllers, etc.) operable in licensed spectrum bands, as well one or more network nodes operable in unlicensed spectrum (using, e.g., LAA or NR-U technology), such as a 2.4-GHz band and/or a 5-GHz band. In such cases, the network nodes comprising RAN 1230 can cooperatively operate using licensed and unlicensed spectrum. In some embodiments, RAN 1230 can include, or be capable of communication with, one or more satellites comprising a satellite access network.

RAN 1230 can further communicate with core network 1240 according to various protocols and interfaces described above. For example, one or more apparatus (e.g., base stations, eNBs, gNBs, etc.) comprising RAN 1230 can communicate to core network 1240 via core network interface 1250 described above. In some exemplary embodiments, RAN 1230 and core network 1240 can be configured and/or arranged as shown in other figures discussed above. For example, eNBs comprising an E-UTRAN 1230 can communicate with an EPC core network 1240 via an S1 interface. As another example, gNBs and ng-eNBs comprising an NG-RAN 1230 can communicate with a 5GC core network 1230 via an NG interface.

Core network 1240 can further communicate with an external packet data network, illustrated in FIG. 12 as Internet 1250, according to various protocols and interfaces known to persons of ordinary skill in the art. Many other devices and/or networks can also connect to and communicate via Internet 1250, such as exemplary host computer 1260. In some exemplary embodiments, host computer 1260 can communicate with UE 1210 using Internet 1250, core network 1240, and RAN 1230 as intermediaries. Host computer 1260 can be a server (e.g., an application server) under ownership and/or control of a service provider. Host computer 1260 can be operated by the OTT service provider or by another entity on the service provider's behalf.

For example, host computer 1260 can provide an over-the-top (OTT) packet data service to UE 1210 using facilities of core network 1240 and RAN 1230, which can be unaware of the routing of an outgoing/incoming communication to/from host computer 1260. Similarly, host computer 1260 can be unaware of routing of a transmission from the host computer to the UE, e.g., the routing of the transmission through RAN 1230. Various OTT services can be provided using the exemplary configuration shown in FIG. 12 including, e.g., streaming (unidirectional) audio and/or video from host computer to UE, interactive (bidirectional) audio and/or video between host computer and UE, interactive messaging or social communication, interactive virtual or augmented reality, etc.

The exemplary network shown in FIG. 12 can also include measurement procedures and/or sensors that monitor network performance metrics including data rate, latency and other factors that are improved by exemplary embodiments disclosed herein. The exemplary network can also include functionality for reconfiguring the link between the endpoints (e.g., host computer and UE) in response to variations in the measurement results. If the network hides or abstracts the radio interface from the OTT service provider, measurements can be facilitated by proprietary signaling between the UE and the host computer.

The exemplary embodiments described herein provide efficient techniques for operation of UE 1210 in relation to RAN 1230 and core network 1240, particularly in relation to mobile terminated early data transmission (MT-EDT). For example, a timing advance (TA) command can be included in a Msg2 during a RA (e.g., CFRA) procedure. The exemplary Msg2 can also include the DL data or a scheduling of resources for the DL data. By using a TA command received in this manner for UL timing alignment, the UE can reliably transmit UL feedback (e.g., ACK/NAK) in response to MT-EDT DL data transmission (e.g., in Msg2), as well as transmitting other responsive UL data as needed. When used in LTE UEs (e.g., UE 1210) and eNBs (e.g., comprising RAN 1230), such embodiments can provide various improvements, benefits, and/or advantages to OTT service providers and end-users, such as more consistent data throughout and fewer delays without excessive UE power consumption or other reductions in user experience.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software.

In addition, a device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. As such, functions described herein as being performed by a wireless device or a network node may be distributed over a plurality of wireless devices and/or network nodes. In other words, it is contemplated that the functions of the network node and wireless device described herein are not limited to performance by a single physical device and can be distributed among several physical devices.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-30. (canceled)

31. A method for a user equipment (UE) to receive downlink user data from a wireless network, the method comprising:
receiving, from a network node in the wireless network, a paging message indicating that downlink user data is available for the UE;
transmitting a random-access (RA) preamble to the network node; and
receiving, from the network node, a response to the RA preamble, the response including:
a timing advance (TA) command for timing alignment of a subsequent transmission by the UE, and
the downlink user data or scheduling information pertaining to the downlink user data.

32. The method of claim 31, wherein one or more of the following applies:
the paging message identifies the RA preamble; and
the RA preamble is a contention-free random access (CFRA) preamble.

33. The method of claim 31, wherein when the response includes the scheduling information, the method further comprises receiving the downlink user data on resources identified by the scheduling information.

34. The method of claim 31, wherein when the response includes the downlink user data:
the response also includes an uplink grant of resources for the subsequent transmission;
the method further comprises performing the subsequent transmission using the resources identified by the uplink grant; and
the subsequent transmission is a positive acknowledgement (ACK) or a negative acknowledgement (NAK) of the downlink user data.

35. The method of claim 34, wherein:
the paging message includes a temporary identifier associated with the UE; and
the ACK or NAK of the downlink user data is transmitted together with the temporary identifier.

36. The method of claim 31, wherein the response is a Media Access Control (MAC) random access response (RAR) protocol data unit (PDU) including:
a MAC header;
one or more RAR fields, one of which includes the TA command; and
a padding field including the downlink user data or the scheduling information.

37. The method of claim 36, wherein the RAR field that includes the TA command also includes a data indicator field having a value that indicates the presence of the downlink data or the scheduling information in the padding field.

38. The method of claim 36, wherein:
the RAR field that includes the TA command also includes one of the scheduling information and an uplink grant of resources for the subsequent transmission; and
the padding field includes the other of the scheduling information and the uplink grant.

39. The method of claim 31, wherein the response is a Media Access Control (MAC) protocol data unit (PDU) including:
a MAC header;
a first MAC control element (CE) that includes the TA command; and
a MAC service data unit (SDU) including the downlink user data.

40. The method of claim 39, wherein the MAC PDU includes a second MAC CE that includes an uplink grant of resources for the subsequent transmission by the UE.

41. A method for a network node, in a wireless network, to transmit downlink user data to a user equipment (UE), the method comprising:
transmitting, to the UE, a paging message indicating that downlink user data is available for the UE;
receiving a random-access (RA) preamble from the UE; and
transmitting, to the UE, a response to the RA preamble, the response including:
a timing advance (TA) command for timing alignment of a subsequent transmission by the UE; and
the downlink user data or scheduling information pertaining to the downlink user data.

42. The method of claim 41, wherein one or more of the following applies:
the paging message identifies the RA preamble; and
the RA preamble is a contention-free random access (CFRA) preamble.

43. The method of claim 41, wherein when the response includes the scheduling information, the method further comprises transmitting the downlink user data on resources identified by the scheduling information.

44. The method of claim 41, wherein when the response includes the downlink user data:
the response also includes an uplink grant of resources for the subsequent transmission;
the method further comprises receiving, from the UE, the subsequent transmission using the resources identified by the uplink grant; and
the subsequent transmission is a positive acknowledgement (ACK) or a negative acknowledgement (NAK) of the downlink user data.

45. The method of claim 44, wherein:
the paging message includes a temporary identifier associated with the UE; and
the ACK or NAK of the downlink user data is received together with the temporary identifier.

46. The method of claim 41, wherein the response is a Media Access Control (MAC) random access response (RAR) protocol data unit (PDU) including:
a MAC header;
one or more RAR fields, one of which includes the TA command; and
a padding field including the downlink user data or the scheduling information.

47. The method of claim 46, wherein the RAR field that includes the TA command also includes a data indicator field having a value that indicates the presence of the downlink data or the scheduling information in the padding field.

48. The method of claim 46, wherein:
the RAR field that includes the TA command also includes one of the scheduling information and an uplink grant of resources for the subsequent transmission; and
the padding field includes the other of the scheduling information and the uplink grant.

49. The method of claim 41, wherein the response is a MAC protocol data unit (PDU) comprising:
a MAC header;
a first MAC control element (CE) that includes the TA command; and
a MAC service data unit (SDU) including the downlink user data.

50. The method of claim 49, wherein the MAC PDU further comprises a second MAC CE that includes an uplink grant of resources for the subsequent transmission by the UE.

51. A user equipment (UE) configured to receive downlink user data from a wireless network, the UE comprising:
radio transceiver circuitry configured to communicate with the wireless network; and
processing circuitry operatively coupled to the radio transceiver circuitry, whereby the processing circuitry and the radio transceiver circuitry are configured to:
receive, from a network node in the wireless network, a paging message indicating that downlink user data is available for the UE;
transmit a random-access (RA) preamble to the network node; and
receive, from the network node, a response to the RA preamble, the response including:
a timing advance (TA) command for timing alignment of a subsequent transmission by the UE, and
the downlink user data or scheduling information pertaining to the downlink user data.

52. A non-transitory, computer-readable medium storing computer-executable instructions that, when executed by processing circuitry of a user equipment (UE), configure the UE to perform operations corresponding to the method of claim 31.

53. A network node, in a wireless network, configured to transmit downlink user data to a user equipment (UE), the network node comprising:
radio network interface circuitry configured to communicate with one or more UEs; and
processing circuitry operatively coupled to the radio network interface circuitry, whereby the processing circuitry and the radio network interface circuitry are configured to perform operations corresponding to the method of claim 41.

54. A non-transitory, computer-readable medium storing computer-executable instructions that, when executed by processing circuitry of a network node in a wireless network, configure the network node to perform operations corresponding to the method of claim 41.
